(19) United States
(12) Patent Application Publication
(10) Pub. No.: US 2004/0102083 A1
(43) Pub. Date: May 27, 2004

(54) Receptacle connector with latch arms and plug connector to be connected thereto

(75) Inventors: Keiji Kuroda, Amagasaki-shi (JP); Kiyoshi Aramoto, Higashiosaka-shi (JP)

Correspondence Address: FASSE PATENT ATTORNEYS, P.A., P.O. BOX 726, HAMPDEN, ME, 04444-0726, US

(73) Assignee: J.S.T. Mfg. Co., Ltd., Osaka (JP)

(21) Appl. No.: 10/719,382

(22) Filed: Nov. 20, 2003

(30) Foreign Application Priority Data
Nov. 22, 2002 (JP) 2002-340081

(51) Int. Cl. H01R 12/24

(52) U.S. Cl. 439/495

(57) ABSTRACT

To provide a receptacle connector and a plug connector, wherein the receptacle connector has a greater force for holding the plug connector in the pull-out direction, verification of their fitting can be done easily and even if the fitting work is done blindly, incomplete fitting will not be made, and these merits can be accomplished while their thicknesses are reduced. A receptacle connector with latch arms comprising a receptacle connector body having a groove into which a plug connector is inserted, a contact provided in the receptacle connector body, and a pair of latch arms extending outward in the depth direction from two locations spaced from each other in the width direction of the receptacle connector body, the pair of latch arms being able to undergo elastic deformation in the width direction. Each latch arm is provided with a retaining part, and the retaining part is provided with a guiding part, a fixed side width fitting face and a fixed side depth fitting face.

### BACKGROUND OF THE INVENTION

1. Field of the Invention

The present invention relates to a receptacle connector and a plug connector for connecting electric wire such as discrete line, coaxial line or twisted cable, or flat type flexible cable such as FFC (flexible flat cable) or FPC (flexible printed circuit) to a counterpart member such as printed circuit board.

2. Related Art

Japanese Patent Unexamined Publication 2001-203047 discloses a receptacle connector comprising an insulator molded into a frame and a plurality of contacts fixed in the insulator, wherein of a pair of opposing side walls constituting the fitting part for fitting with a plug connector, one side wall is formed by a first shell of a metal and the other side wall is integrally molded by the above-mentioned insulator.

Japanese Patent Unexamined Publication 2001-351734 discloses a connector comprising a contact for contacting an object to be connected, a housing for holding the contact and latch arms being combined with the housing and being for holding the object to be connected through fitting, the connector characterized in that the latch arm comprises a holding part to be fixed onto and held by the housing, a fitting part for fitting with the object to be connected, and an elastic deformation part being located between the holding part and the fitting part and being able to undergo elastic deformation, the holding part and the elastic deformation part are made of a metal, and the fitting part is made of a resin.

When a plug connector is fitted into the receptacle connector of Japanese Patent Unexamined Publication 2001-203047, the plug connector will be held in the receptacle connector due to a fitting force between both housings and a frictional force that is generated by the contact pressing the plug connector due to the contact's elastic restoring force. Accordingly, even if a pull-out force is applied to the plug connector, the plug connector will be held in the receptacle connector against the pull-out force. However, if a pull-out force greater than the holding force is applied, the plug connector will be pulled out. In particular, when the receptacle connector and the plug connector are to be reduced in thickness, the contact area between their housings will get smaller and the amount of elastic displacement of their contacts can not be large. Hence it is difficult to secure a sufficient holding force of the plug connector, and it is highly desired to increase this holding force as much as possible.

In fitting a plug connector into such a receptacle connector, it is not possible to verify whether the fitting is achieved up to the predetermined depth. Accordingly, when the fitting work is done blindly by extending a hand behind an object, the fitting can not be verified visually and it is hard to prevent imperfect fitting.

### SUMMARY OF THE INVENTION

The present invention was made in view of the above-mentioned points, and its objective is to provide a receptacle connector and a plug connector, wherein the receptacle connector has a greater force for holding the plug connector in the pull-out direction, verification of their fitting can be done easily and even if the fitting work is done blindly, incomplete fitting will not be made, and these merits can be accomplished while their thicknesses are reduced, by providing the receptacle connector with latch arms extending substantially in the pull-out direction of the plug connector and inserting the plug connector into the receptacle connector slantwise in relation to the pull-out direction of the plug connector, then laying the plug connector towards the latch arms to fit the plug connector with the latch arms.

To accomplish the above-mentioned objective, the receptacle connector with latch arms according to the present invention is a receptacle connector with latch arms, which is to be mounted on a counterpart member and to which a plug connector being connected to an electric wire or a flat type flexible cable is to be connected, when a depth direction, a width direction and a thickness direction all being perpendicular to each other are assumed, the plug connector is, when seen in the thickness direction, substantially a rectangle having the depth direction and the width direction as its two sides, a contact is exposed on at least one face thereof in the thickness direction at the inward edge in the depth direction, and a moving side width fitting face facing outward in the width direction and a moving side depth fitting face facing outward in the depth direction are provided at two locations spaced from each other in the width direction, the receptacle connector with latch arms comprises a receptacle connector body having a groove comprising two transverse walls opposing to each other in the thickness direction and a vertical wall present between the two transverse walls, the groove opening outward in the depth direction and into which the inward edge in the depth direction of the plug connector is to be inserted, the receptacle connector body being at least partly insulating, a conductive contact comprising a contacting part being able to undergo elastic deformation in the thickness direction in the groove of the receptacle connector body to contact the contact of the plug connector, and a connecting part to be connected to the counterpart member, the contact being provided in an insulating part of the receptacle connector body, and a pair of latch arms extending outward in the depth direction from two locations being spaced from each other in the width direction on the receptacle connector body and being able to undergo elastic deformation in the width direction, and each latch arm is provided with a retaining part projecting inward in the width direction, and the retaining part is provided with a guiding part that generates a component force acting outward in the width direction from a pressing force acting on the guiding part from the side opposite to the counterpart member in the thickness direction, a fixed side width fitting face facing inward in the width direction corresponding to the moving side width fitting face of the plug connector, and a fixed side depth fitting face facing inward in the depth direction corresponding to the moving side depth fitting face of the plug connector.

When the plug connector is to be inserted into this receptacle connector, the plug connector is held slantwise in such a way that its outward edge in the depth direction is more distant than its inward edge from the receptacle connector, the inward edge is inserted into the groove of the receptacle connector, and the plug connector is laid in such a way that its outward edge comes closer to the latch arms of the receptacle connector. As a result, the bottom being one face in the thickness direction of the plug connector will press the guiding parts of the retaining parts of the latch arms, and in turn the guiding parts will generate component force acting outward in the width direction from the pressing force of the plug connector, and the latch arms will be bent by the these forces outward in the width direction. When the plug connector is laid further, the part outward in the depth direction of the plug connector will enter beyond the retaining parts of the latch arms into the counterpart member side and fit in a space between the two latch arms, and the plug connector will be held in its laid state by the retaining parts of the latch arms that recover themselves because of their elastic restoring forces, and the fixed side width fitting faces will make surface-to-surface contact with the moving side width fitting faces of the plug connector, the fixed side depth fitting faces will make surface-to-surface contact with the moving side depth fitting faces of the plug connector, thus both connectors will be connected together mechanically. Moreover, their respective contacts will contact together, and the contact pressures between them will be assured by the elastic restoring forces due to the elastic deformation of the contacts, thus both connectors will be connected together electrically. To pull the plug connector out of the receptacle connector, the latch arms are bent outward in the width direction. Then the plug connector will be freed from the restraint imposed by the retaining parts, and due to the elastic-deformation-induced forces of the contacts, the outside part in the depth direction of the plug connector will go beyond the retaining parts of the latch arms in the direction of moving away from the counterpart member, and the plug connector will take a slant position in such a way that the outward edge in the depth direction thereof is more distant than the inward edge thereof from the receptacle connector, and in turn, the plug connector will be able to be pulled out.

In that case, as the fixed side depth fitting faces facing in the depth direction and the moving side depth fitting faces also facing in the depth direction make surface-to-surface contact with each other, the plug connector has a large holding force in the pull-out direction, in other words, the direction of pulling outward in the depth direction. Moreover, if the plug connector is slant in such a way that the outward edge in the depth direction thereof is more distant than the inward edge from the receptacle connector, the plug connector is not fitted in the receptacle connector, and if the plug connector is laid and set between the two latch arms, the plug connector is fitted in the receptacle connector. Thus the position or attitude of the plug connector indicates whether it is fitted in or not. Moreover, when the latch arms restore themselves due to their elastic restoring forces and the fixed side width fitting faces make surface-to-surface contact with the moving side width fitting faces of the plug connector and the fixed side depth fitting faces make surface-to-surface contact with the moving side depth fitting faces of the plug connector, a sense of clicking will be obtained. Hence it is easy to verify the fitting condition, and even if the fitting work is done blindly, defective fitting will not be resulted.

As the receptacle connector of the present invention is provided with latch arms extending substantially in the pull-out direction of the plug connector, and the plug connector is inserted into the receptacle connector slantwise in relation to the pull-out direction of the plug connector and after that the plug connector is laid towards the latch arms to fit with the latch arms, the holding force of the plug connector in the pull-out direction can be increased, and the fitting verification is easy and even if the fitting work is done blindly, any defective fitting can be avoided reliably, and these merits can be obtained while efforts are made to make the connectors thinner.

### BRIEF DESCRIPTION OF THE DRAWINGS

FIG. 1 is a perspective view of the receptacle connector of an embodiment.

FIG. 2 is a perspective view showing the receptacle connector of the embodiment from a different angle.

FIG. 3 is a plan view of the receptacle connector of the embodiment.

FIG. 4 is a front view of the receptacle connector of the embodiment.

FIG. 5 is a side view of the receptacle connector of the embodiment.

FIG. 6 is an enlarged front view of the top end of the latch arm of the receptacle connector of the embodiment.

FIG. 7 is an enlarged plan view of the top end of the latch arm of the receptacle connector of the embodiment.

FIG. 8 is a perspective view of the plug connector of the embodiment.

FIG. 9 is a perspective view showing the plug connector of the embodiment seen from the bottom side thereof.

FIG. 10 is a bottom view of the plug connector of the embodiment.

FIG. 11 is a rear view of the plug connector of the embodiment.

FIG. 12 is a side view of the plug connector of the embodiment.

FIG. 13 is a perspective view showing an edge of the plug connector of the embodiment being inserted into a groove of the receptacle connector.

FIG. 14 is a perspective view showing the edge of the plug connector of the embodiment having been inserted into the groove of the receptacle connector.

FIG. 15 is a perspective view showing the plug connector that has been laid from the state shown in FIG. 14 and connected to the receptacle connector.

FIG. 16 is an enlarged sectional view showing the receptacle connector and the plug connector of the embodiment. The edge of the plug connector is being inserted in the groove of the receptacle connector.

FIG. 17 is an enlarged sectional view of the receptacle connector and the plug connector of the embodiment. The plug connector has been connected to the receptacle connector.

### PREFERRED EMBODIMENT OF THE INVENTION

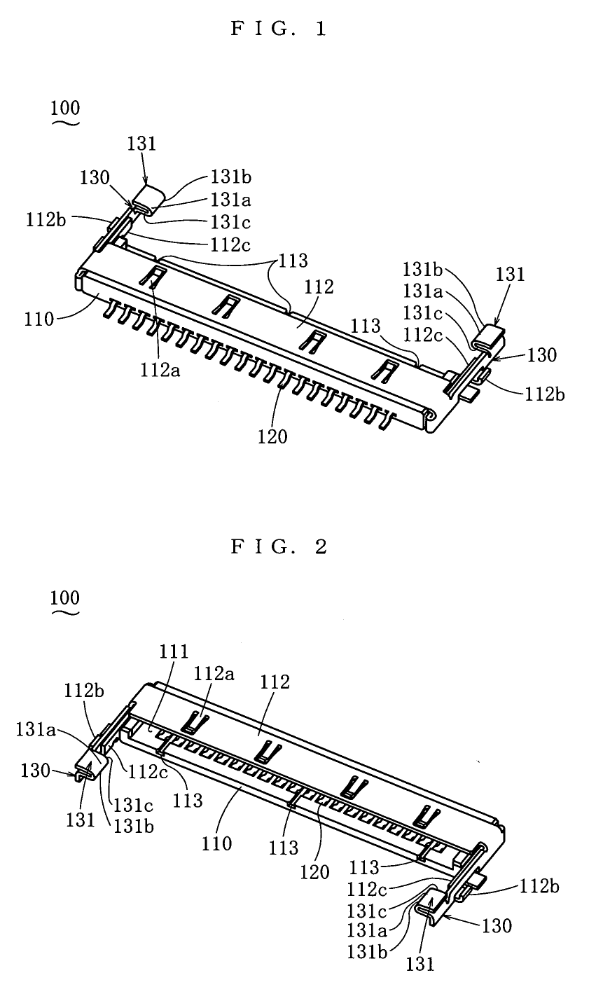

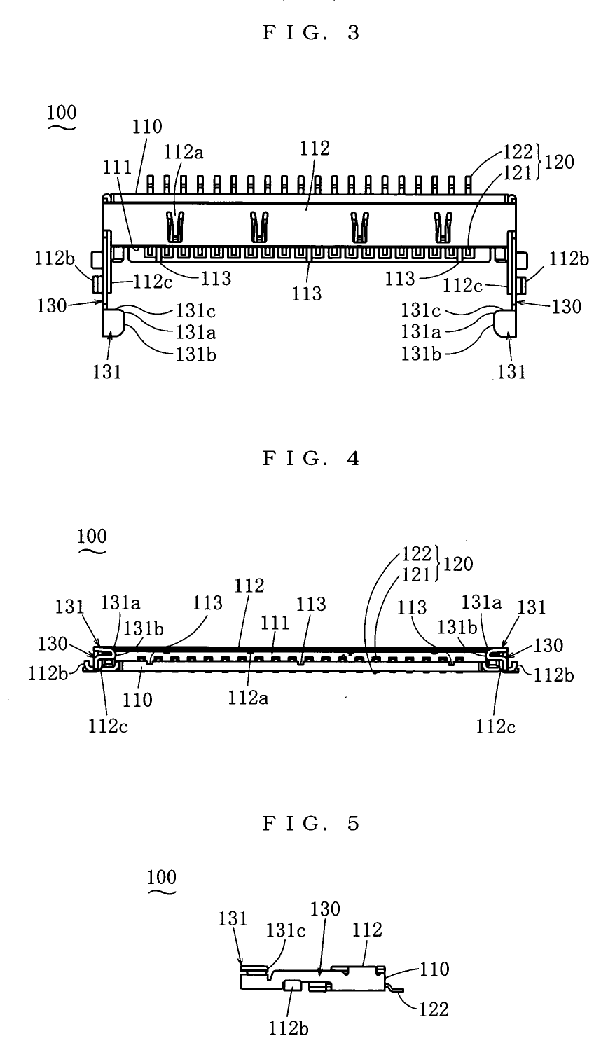

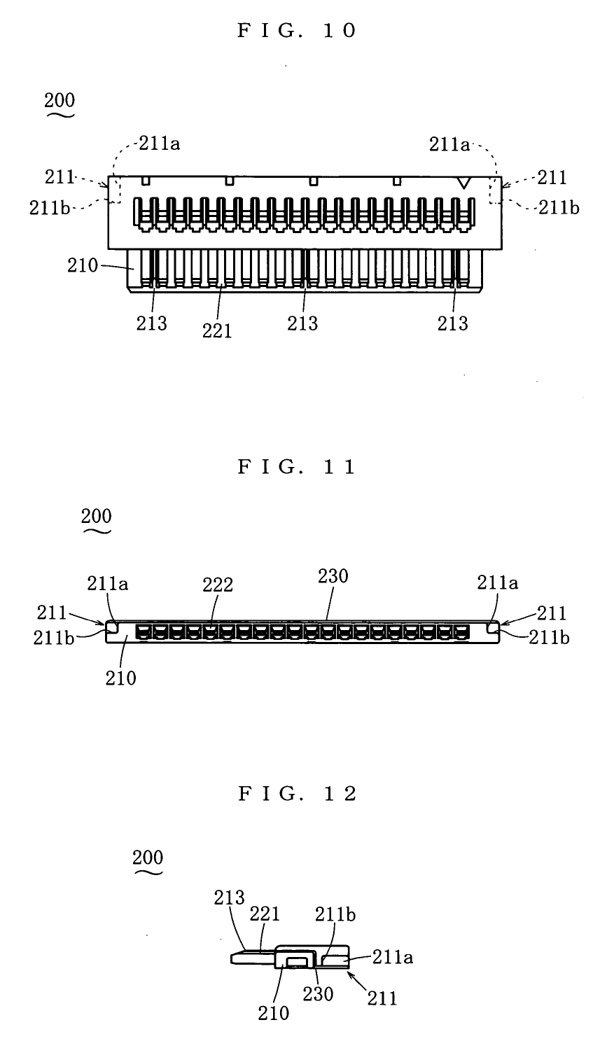

In the following an embodiment of the present invention will be described. FIG. 1 through FIG. 17 show the embodiment of the receptacle connector with latch arms 100 and the plug connector 200 to be connected thereto according to the present invention. The receptacle connector 100 and the plug connector 200 are used to connect an electric wire W such as discrete line, coaxial line or twisted cable or a flat type flexible cable such as FFC or FPC to a counterpart member A having conductor such as printed circuit board. Here a case will be described as an example, wherein of various electric wires W, a plurality of discrete lines that are independent to each other are to be connected to a liquid crystal panel being a counterpart member A.

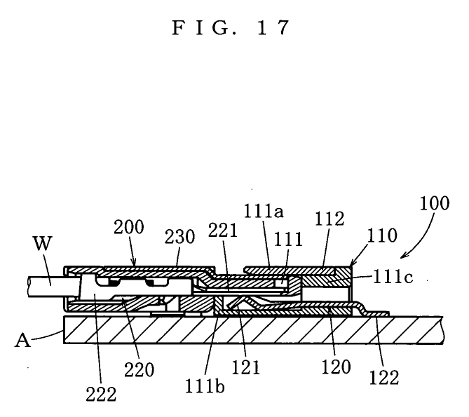

First the receptacle connector 100 will be described. In this case a depth direction, a width direction and a thickness direction, which are perpendicular to each other, are assumed and this orientation is used for description. In the case of the embodiment, with reference to FIG. 3, the top-bottom direction of the diagram is the depth direction, and the lower part of the diagram is outward in the depth direction, and the upper part of the diagram is inward in the depth direction. The left-right direction of FIG. 3 is the width direction, and the direction perpendicular to the plane of the paper is the thickness direction. As shown in FIG. 1 through FIG. 5, the receptacle connector 100 comprises a receptacle connector body 110, at least a part thereof being electrically insulating, conductive contacts 120 being provided in the insulating part of the receptacle connector body 110, and a pair of latch arms 130 provided on the receptacle connector body 110. As shown in FIG. 16 and FIG. 17, the receptacle connector body 110 comprises two transverse walls 111a, 111b opposing to each other in the thickness direction, and a vertical wall 111c provided between the two transverse walls 111a, 111b, and the receptacle connector body 110 has a groove 111 comprising these walls 111a, 111b and 111c and opening outward in the depth direction.

As shown in FIG. 16 and FIG. 17, each contact 120 comprises a contacting part 121 that can undergo elastic deformation in the thickness direction in the groove 111 of the receptacle connector body 110, and a connecting part 122 to be connected to the counterpart member A, and is provided in the insulating part of the receptacle connector body 110. The contacts 120 are provided in the insulating part of the receptacle connector body 110 by press fit or integral molding using casting; the contacts 120 and the receptacle connector body 120 may be fitted together with housing lance or contact lance. In this embodiment the contacting parts 121 of the contacts 120 are arranged in such a way that they come out of the transverse wall 111b being closer to the counterpart member A into the groove 111, but the contacting parts 121 thereof may come out of the transverse wall 111a being more distant from the counterpart member A into the groove 111, or the contacting parts 121 thereof may be arranged in both transverse walls 111a, 111b. In any case, they are arranged in the following manner. When the plug connector 200, which will be described later, is held slantwise in such a way that its outward edge in the depth direction is more distant from the receptacle connector 100 than its inward edge, and the inward edge is inserted into the groove 111 of the receptacle connector 100, then the outward edge is tilted towards the latch arms 130 of the receptacle connector 100, the inward edge of the plug connector 200 will press the contacts 120 in the thickness direction according to the principle of lever. In the case of this embodiment the fulcrum of the lever is provided by a portion of the plug connector 200, the portion being in contact with the outward edge in the depth direction of the transverse wall 111a being more distant from the counterpart member A.

On the receptacle connector body 110, the pair of latch arms 130, 130 extend outward in the depth direction from two locations being spaced from each other in the width direction. Each latch arm 130 is made of an elastic member and can undergo elastic deformation in the width direction.

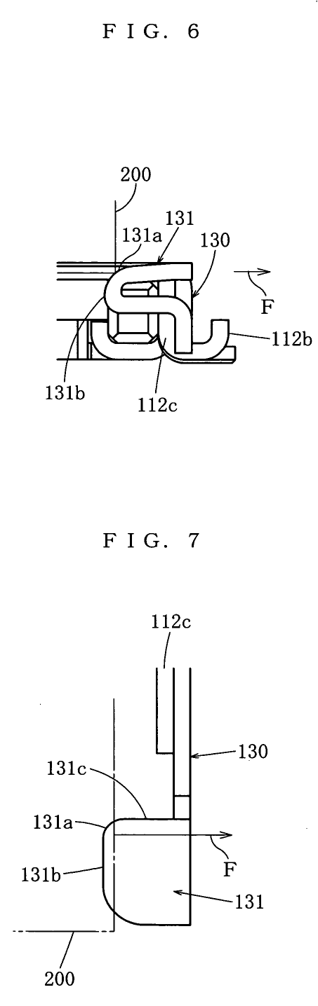

As shown in FIG. 6, each latch arm 130 is provided with a retaining part 131 projecting inward in the width direction. The retaining part 131 is provided with a guiding part 131a that generates a component force acting outward in the width direction from a pressing force acting on the guiding part 131a from the side opposite to the counterpart member in the thickness direction, a fixed side width fitting face 131b facing inward in the width direction, and a fixed side depth fitting face 131c facing inward in the depth direction.

In the case of this embodiment, when seen in the thickness direction, the retaining part 131 is substantially a rectangle having the depth direction and the width direction as its two sides. As shown in FIG. 6, the retaining part 131 is provided with a portion on its face opposite to the side of the counterpart member A, the portion tilting inward in the width direction and coming closer to the counterpart member A, and this portion provides the guiding part 131a. The inward end face in the width direction of the retaining part 131 provides the fixed side width fitting face 131b. Moreover, the inward end face in the depth direction of the retaining part 131 provides the fixed side depth fitting face 131c. Further, as shown in FIG. 7, the corner inward in the width direction and inward in the depth direction of the retaining part 131 is chamfered when seen in the thickness direction to provide the guiding part 131a. One of the guiding parts 131a of these two kinds may be provided rather than providing them together as shown above.

In the case of this embodiment, the surface of the receptacle connector body 110 on the side opposite to the counterpart member A is provided by a metallic cover 112. The cover 112 is, when seen in the thickness direction, substantially a rectangle having the depth direction and the width direction as its two sides. The two latch arms are made of a metal, and the root end of each latch arm 130 is integrally provided on both ends in the width direction of the cover 112. The cover 112 constitutes the transverse wall 111a of the groove 111 of the receptacle connector body 110. Fixation of the cover 112 onto the insulating part of the receptacle connector body 110 is done by, for example, press fit or integral molding using casting. The cover 112 is provided with contacting pieces 112a if need arises. When connection with the plug connector 200 is made, which will be described later, these contacting pieces 112a will contact the cover 230 of the plug connector 200 to ensure continuity between the covers 112, 230. The contacting pieces 112a are cut and raised from the cover 112 but the structure is not limited by this manner. If the receptacle connector body 110 is provided with a metallic reinforcing tab that can be mounted on the grounding part of the counterpart member A and this tab and the cover 112 are connected to each other, both covers 112, 230 can be connected to the grounding part of the counterpart member A. If need arises, the cover 112 is provided with outer stoppers 112b that are located outside in the width direction of the latch arms 130 and inward stoppers 112c that are located inside in the width direction of the latch arms 130. The former and the latter are arranged to restrain the latch arms 130 from excessive deformation outward and inward in the width direction, respectively.

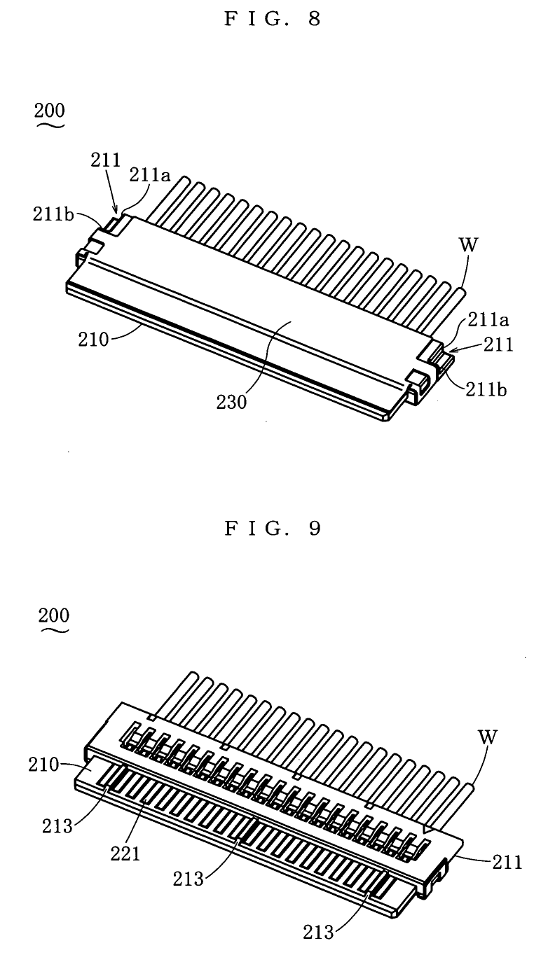

Next, the plug connector 200 to be connected to the above-mentioned receptacle connector 100 will be described. In this case, a depth direction, a width direction and a thickness direction that are perpendicular to each other are assumed, and this orientation is used for description. In the case of this embodiment, with reference to FIG. 10, the top-bottom direction of the diagram is the depth direction, and the upper part of the diagram is outward in the depth direction, and the lower part of the diagram is inward in the depth direction. The left-right direction of FIG. 10 is the width direction, and the direction perpendicular to the paper plane is the thickness direction. As shown in FIG. 8 through FIG. 12, this plug connector 200 comprises an insulating plate-shaped plug connector body 210 and conducting contacts 220 provided on the plug connector body 210.

The plug connector body 210 is, when seen in the thickness direction, substantially a rectangle having the depth direction and the width direction as its two sides. As shown in FIG. 12, it is preferable that the inward edge in the depth direction of the plug connector body 210 be wedge-shaped when seen in the width direction to get thinner towards the top end thereof. With this arrangement, it is easier to insert the plug connector body 210 into the groove 111 of the receptacle connector 100. Shaping the edge into such a wedge form can be done if need arises.

The contact 220 comprises a contacting part 221 that is exposed at the inward edge in the depth direction of the plug connector body 210 at least one face in the thickness direction thereof and a connecting part 222 to be connected to an electric wire W. The contacts 220 are fitted onto the plug connector body 210 with housing lances, but they may be fitted together with contact lances, and contacts 220 may be provided on the plug connector body 210 by, for example, press fit or integral molding using casting.

A moving side width fitting face 211a facing outward in the width direction and a moving side depth fitting face 211b facing outward in the depth direction are provided at two locations being spaced from each other in the width direction on the plug connector body 210.

In the case of this embodiment, concaved parts 211 concaving in the thickness direction are provided in corners at both ends in the width direction and outward in the depth direction of the plug connector body 210. Of the walls constituting these concaved parts 211, walls facing outward in the width direction are the moving side width fitting faces 211a. And of the walls constituting these concaved parts 211, walls facing outward in the depth direction are the moving side depth fitting faces 211b.

230 is the metal cover, and this cover 230 is, when seen in the thickness direction, substantially a rectangle having the depth direction and the width direction as its two sides. The cover 230 is placed over the plug connector body 210 in the thickness direction. Fixation of the cover 230 onto the plug connector body 210 is done by, for example, press fit or integral molding using casting. This cover 230 may be provided if need arises.

The receptacle connector 100 and the plug connector 200 are provided, if need arises, with fitting parts 113, 213 for prevention of incorrect insertion, respectively. In other words, in either one of the receptacle connector body 110 and the plug connector body 210 grooves extending in the depth direction are provided at appropriate locations in the width direction, and on the other body ribs that fit into the grooves are provided. Various pairs of one receptacle connector 100 and one plug connector 200 may be formed for different number of poles in some cases. When a proper combination of a receptacle connector 100 and a plug connector 200 is selected and connected, they will be connected successfully with their fitting parts 113, 213 being fitted together. If a receptacle connector 100 and a plug connector 200, of which pole numbers differ from each other, are connected inadvertently, they can not be connected successfully because their fitting parts 113, 213 do not fit together; thus incorrect insertion is prevented. If the plug connector 200 is inserted slantwise into the receptacle connector 100 and the receptacle connector 100 is pried, the receptacle connector 100 or the plug connector 200 may be damaged. However, in case of the slantwise insertion, the fitting parts 113, 213 will not fit together, and one will notice the incorrect insertion; thus damages can be prevented.

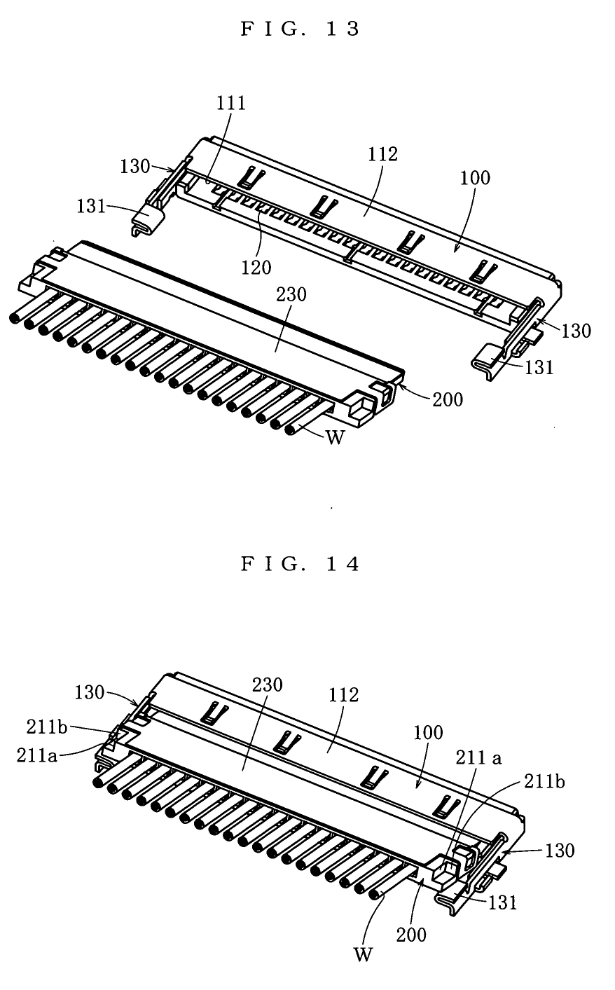

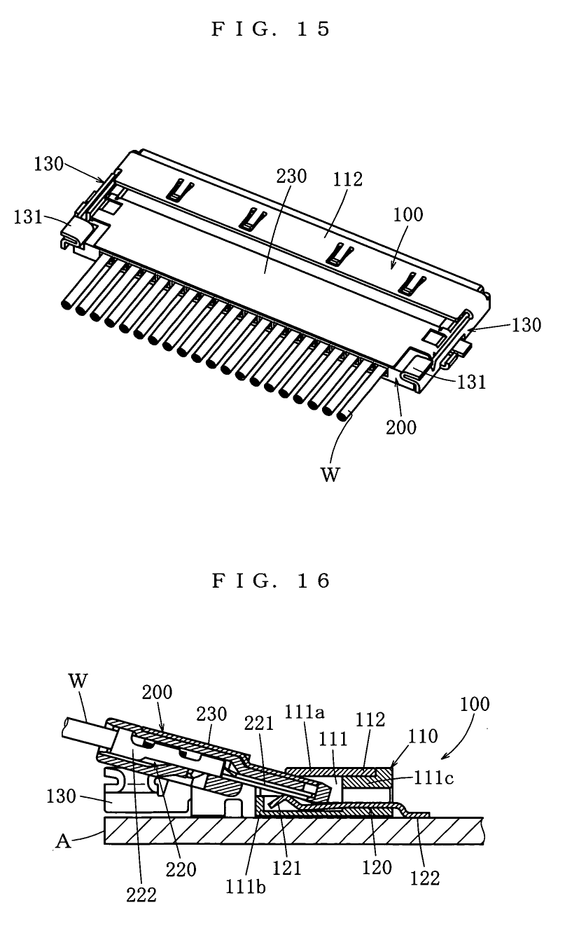

When the plug connector 200 is to be inserted into the receptacle connector 100, the plug connector 200 is held slantwise in such a way that the outward edge in the depth direction is more distant than the inward edge from the receptacle connector 100 (refer to FIG. 13), the inward edge is inserted into the groove 111 of the receptacle connector 100 (refer to FIG. 14), and then the plug connector 200 is laid in such a way that the outward edge comes closer to the latch arms 130 of the receptacle connector 100. As a result, the bottom being one face in the thickness direction of the plug connector 200 will press the guiding parts 131a of the retaining parts 131 of the latch arms 130, and in turn the guiding parts 131a will generate component forces F acting outward in the width direction (refer to FIG. 6 and FIG. 7) from the pressing force of the plug connector 200, and the latch arms 130 will be bent by the forces F outward in the width direction. When the plug connector 200 is laid further, the part outward in the width direction of the plug connector 200 will enter beyond the retaining parts 131 of the latch arms 130 into the counterpart member side and fit in a space between the two latch arms 130, 130, and the plug connector 200 will be held in its laid state by the retaining parts 131 of the latch arms 130 that recover themselves because of their elastic restoring forces, and the fixed side width fitting faces 131b will make surface-to-surface contact with the moving side width fitting faces 211a of the plug connector 200, the fixed side depth fitting faces 131c will make surface-to-surface contact with the moving side depth fitting faces 211b of the plug connector 200, thus both the connectors 100, 200 will be connected together mechanically (refer to FIG. 15). Moreover, the contacts 220 will contact the contacts 120, and the contact pressures between the contacts 220 and the contacts 120 will be assured by the elastic restoring forces due to the elastic deformation of the contacts 120, thus both the connectors 100, 200 will be connected together electrically. To pull the plug connector 200 out of the receptacle connector 100, the latch arms 130 are bent outward in the width direction. Then the plug connector 200 will be freed from the restraint imposed by the retaining parts 131, and due to the elastic-deformation-induced forces of the contacts 120, the outside part in the depth direction of the plug connector 200 will go beyond the retaining parts 131 of the latch arms 130 in the direction of moving away from the counterpart member A, and the plug connector 200 will take a slant position in such a way that the outward edge in the depth direction thereof is more distant than the inward edge thereof from the receptacle connector 100, and in turn, the plug connector 200 will be able to be pulled out.

In that case, as the fixed side depth fitting faces 131c facing in the depth direction and the moving side depth fitting faces 211b facing in the depth direction make surface-to-surface contact with each other, the plug connector 200 has a large holding force in the pull-out direction, in other words, the direction of pulling outward in the depth direction. Moreover, if the plug connector 200 is slant in such a way that the outward edge in the depth direction thereof is more distant than the inward edge from the receptacle connector 100, the plug connector 200 is not fitted in the receptacle connector 100, and if the plug connector 200 is laid and set between the two latch arms 130, 130, the plug connector 200 is fitted in the receptacle connector 100. Thus the position or attitude of the plug connector 200 indicates whether it is fitted or not. Moreover, when the latch arms 130 restore themselves due to their elastic restoring forces and the fixed side width fitting faces 131b make surface-to-surface contact with the moving side width fitting faces 211a of the plug connector 200 and the fixed side depth fitting faces 131c make surface-to-surface contact with the moving side depth fitting faces 211b of the plug connector 200, a sense of clicking will be obtained. Hence it is easy to verify the fitting condition, and even if the fitting work is done blindly, defective fitting will not be resulted. Accordingly, with the receptacle connector with latch arms 100 of the embodiment, the holding force of the plug connector 200 in the pull-out direction can be increased, and the fitting verification is easy and even if the fitting work is done blindly, any defective fitting can be avoided reliably, and these merits can be obtained while efforts are made to make the connectors thinner.

According to the present invention, each latch arm is provided with a retaining part projecting inward in the width direction, and this retaining part is provided with a guiding part that generates a component force acting outward in the width direction from a pressing force acting on the guiding part from the side opposite to the counterpart member in the thickness direction, a fixed side width fitting face facing inward in the width direction, and a fixed side depth fitting face facing inward in the depth direction, and no more limitations are given to the construction of the retaining parts. In the case of this embodiment, when seen in the thickness direction, the retaining part 131 is substantially a rectangle having the depth direction and the width direction as its two sides, and the retaining part 131 is provided with a portion on its face opposite to the side of the counterpart member, the portion tilting inward in the width direction and coming closer to the counterpart member A, and this portion provides the guiding part 131a, or the corner inward in the width direction and inward in the depth direction of the retaining part 131 is chamfered to provide the guiding part 131a, and the inward end face in the width direction of the retaining part 131 provides the fixed side width fitting face 131b, and the inward end face in the depth direction of the retaining part 131 provides the fixed side depth fitting face 131c. With this arrangement, as shown in FIG. 6 or FIG. 7, in inserting the plug connector 200 into the receptacle connector 100, when the plug connector 200 is laid in such a way that the outward edge in the depth direction thereof comes closer to the latch arms 130 of the receptacle connector 100, the edges in the width direction of the bottom of the plug connector 200 will contact the guiding parts 131a of the latch arms 130 of the receptacle connector 100, and when the plug connector 200 is laid further, these contacting parts will be moved along the slanted portions or the chamfered lines of the guiding parts 131a. During that time, the guiding parts 131a will generate component forces F acting outward in the width direction from the pressing force of the plug connector 200, and the latch arms 130 will be bent outward in the width direction by these component forces F. When the plug connector 200 is laid more, the plug connector 200 will be moved beyond the retaining parts 131 of the latch arms 130 and set in the space between the two latch arms 130, 130, and will be held in the laid state by the retaining parts 131 of the latch arms 130 restoring themselves due to their elastic restoring forces, and the fixed side width fitting faces 131b will make surface-to-surface contact with the moving side width fitting faces 211a of the plug connector 200, and the fixed side depth fitting faces 131c will make surface-to-surface contact with the moving side depth fitting faces 211b of the plug connector 200. Accordingly, with a simple construction, the latch arm 130 can be provided with the guiding part 131a, fixed side width fitting face 131b and fixed side depth fitting face 131c.

The latch arms according to the present invention extend towards outward in the depth direction from two locations on the receptacle connector body 110, the two locations being spaced from each other in the width direction, and are required to be able to undergo elastic deformation in the width direction. In the case of the above-mentioned embodiment, the surface of the receptacle connector body 110 on the side opposite to that of the counterpart member A is provided by a metallic cover 112, and the two latch arms 130, 130 are made of a metal, and the root ends of the respective latch arms 130 are integrally provided on both ends in the width direction of the cover 112. With this arrangement, the mounting strength of the latch arms 130 is improved, and the latch arms 130 can reliably tolerate repetition of insertion and pullout of the plug connector 200 to extend the service life of the receptacle connector 100. Moreover, the cover 112 exhibits shielding effect.

The plug connector 200 of the embodiment is preferable as a plug connector to be connected to the above-mentioned receptacle connector 100. According to the present invention, it is sufficient to provide a moving side width fitting face facing outward in the width direction and a moving side depth fitting face facing outward in the depth direction at each of two locations on the plug connector body, the locations being spaced in the width direction thereof. In the case of the above-mentioned embodiment, concaved parts 211 concaving in the thickness direction are provided in the corners, at both ends in the width direction and outward in the depth direction, of the plug connector body 210. Of the walls constituting these concaved parts 211, walls facing outward in the width direction provide the moving side width fitting faces 211a, and walls facing outward in the depth direction provide the moving side depth fitting faces 211b. With this arrangement, in inserting the plug connector 200 into the receptacle connector 100, when the plug connector 200 is laid further after the latch arms 130 have been bent outward in the width direction, the plug connector 200 will be moved beyond the retaining parts 131 of the latch arms 130 and set in the space between the two latch arms 130, 130, and will be held in the laid state by the retaining parts 131 of the latch arms 130 restoring themselves due to their elastic restoring forces, the retaining parts 131 staying in the concaved parts 211 of the plug connector 299 and pressing the bottoms of the concaved parts 211, and the fixed side width fitting faces 131b of the receptacle connector 100 will make surface-to-surface contact with the moving side width fitting faces 211a of the plug connector 200, and the fixed side depth fitting faces 131c of the receptacle connector 100 will make surface-to-surface contact with the moving side depth fitting faces 211b of the plug connector 200. Accordingly, with this simple construction, the plug connector 200 can be provided with the moving side width fitting faces 211a and the moving side depth fitting faces 211b.

In the above-mentioned embodiment, electric wires W are used, but flat type flexible cables may be used. In such a case the connecting parts 222 of the contacts 220 are arranged for connecting flat type flexible cables.

With the description of these embodiments the first receptacle connector with latch arms that was explained in Summary of the Invention above has been described fully. Moreover, with the description of these embodiments the second receptacle connector with latch arms and the third receptacle connector with latch arms, which are to be explained below, and the first plug connector and the second plug connector have been described fully.

The second receptacle connector with latch arms is the first receptacle connector with latch arms wherein the retaining part is, when seen in the thickness direction, substantially a rectangle having the depth direction and the width direction as its two sides, and the retaining part is provided with a portion on its face opposite to the side of the counterpart member, the portion tilting inward in the width direction and coming closer to the counterpart member, and this portion provides the guiding part, or the corner inward in the width direction and inward in the depth direction of the retaining part is, when seen in the thickness direction, chamfered to provide the guiding part, and the inward end face in the width direction of the retaining part provides the fixed side width fitting face, and the inward end face in the depth direction of the retaining part provides the fixed side depth fitting face.

With this arrangement, in inserting the plug connector into the receptacle connector, when the plug connector is laid in such a way that its outward edge in the depth direction comes closer to the latch arms of the receptacle connector, the edges in the width direction of the bottom of the plug connector will contact the guiding parts of the latch arms of the receptacle connector, and when the plug connector is laid further, these contacting parts will be moved along the slanted portions or the chamfered lines of the guiding parts. During that time, the guiding parts will generate component forces acting outward in the width direction from the pressing force of the plug connector, and the latch arms will be bent outward in the width direction by these component forces. When the plug connector is laid more, the plug connector will be moved beyond the retaining parts of the latch arms and set in the space between the two latch arms, and will be held in the laid state by the retaining parts of the latch arms restoring themselves due to their elastic restoring forces, and the fixed side width fitting faces will make surface-to-surface contact with the moving side width fitting faces of the plug connector, and the fixed side depth fitting faces will make surface-to-surface contact with the moving side depth fitting faces of the plug connector.

In the second receptacle connector with latch arms, with the simple construction, the latch arms can be provided with the guiding parts, fixed side width fitting faces and fixed side depth fitting faces.

The third receptacle connector with latch arms is the first or second receptacle connector with latch arms wherein the surface of the receptacle connector body on the side opposite to the counterpart member is provided by a metallic cover, and the two latch arms are made of a metal, and the root ends of the respective latch arms are integrally provided on both ends in the width direction of the cover.

With this arrangement, the mounting strength of the latch arms is enhanced, and the latch arms can reliably endure repetition of insertion and pullout of the plug connector to extend the service life of the receptacle connector. Moreover, the cover exhibits shielding effect.

In the third receptacle connector with latch arms the mounting strength of the latch arms is enhanced, the latch arms reliably endure repetition of insertion and pullout of the plug connector, and the service life of the receptacle connector is extended. Moreover, the cover provides shielding function.

The first plug connector is a plug connector to be connected to any one of the first through third receptacle connectors with latch arms, and the first plug connector comprises, when a depth direction, a width direction and a thickness direction all being perpendicular to each other are assumed, an insulating plate-shaped plug connector body being, when seen in the thickness direction, substantially a rectangle having the depth direction and the width direction as its two sides, and the contact having conductivity and being provided on the plug connector body, the contact comprising a contacting part being exposed at the inward edge in the depth direction of the plug connector body at least on one face in the thickness direction thereof and a connecting part to be connected to the electric wire or the flat type flexible cable, and the moving side width fitting face facing outward in the width direction and the moving side depth fitting face facing outward in the depth direction, the both faces being provided on the plug connector body at two locations spaced from each other in the width direction thereof.

This plug connector is preferable as a plug connector to be connected to any one of the first through third receptacle connectors. The procedure of connection and effects are just as described for the first through third receptacle connectors.

The first plug connector is preferable as a plug connector to be connected to any one of the first through third receptacle connectors with latch arms.

The second plug connector is the first plug connector wherein concaved parts concaving in the thickness direction are provided in the corners at both ends in the width direction and outward in the depth direction of the plug connector body, and of the walls constituting these concaved parts, walls facing outward in the width direction provide the moving side width fitting faces and walls facing outward in the depth direction provide the moving side depth fitting faces.

With this arrangement, in inserting the plug connector into the receptacle connector, when the plug connector is laid further after the latch arms have been bent outward in the width direction, the plug connector will go beyond the retaining parts of the latch arms and set in the space between the two latch arms, and the plug connector will be held in the laid state by the retaining parts of the latch arms restoring themselves due to the elastic restoring forces, the retaining parts entering the concaved parts of the plug connector and pushing the bottoms of the concaved parts, and the fixed side width fitting faces of the receptacle connector will make surface-to-surface contact with the moving side width fitting faces of the plug connector, and the fixed side depth fitting faces of the receptacle connector will make surface-to-surface contact with the moving side depth fitting faces of the plug connector.

In the second plug connector, with the simple construction, the plug connector can be provided with moving side width fitting faces and moving side depth fitting faces.

What is claimed is:

1. A receptacle connector with latch arms, which is to be mounted on a counterpart member and to which a plug connector being connected to an electric wire or a flat type flexible cable is to be connected, when a depth direction, a width direction and a thickness direction all being perpendicular to each other are assumed,
the plug connector is, when seen in the thickness direction, substantially a rectangle having the depth direction and the width direction as its two sides, a contact is exposed on at least one face thereof in the thickness direction at the inward edge in the depth direction, and a moving side width fitting face facing outward in the width direction and a moving side depth fitting face facing outward in the depth direction are provided at two locations spaced from each other in the width direction,
the receptacle connector with latch arms comprises
a receptacle connector body having a groove comprising two transverse walls opposing to each other in the thickness direction and a vertical wall present between the two transverse walls, the groove opening outward in the depth direction and into which the inward edge in the depth direction of the plug connector is to be inserted, the receptacle connector body being at least partly insulating,
a conductive contact comprising a contacting part being able to undergo elastic deformation in the thickness direction in the groove of the receptacle connector body to contact the contact of the plug connector, and a connecting part to be connected to the counterpart member, the contact being provided in an insulating part of the receptacle connector body, and
a pair of latch arms extending outward in the depth direction from two locations being spaced from each other in the width direction on the receptacle connector body and being able to undergo elastic deformation in the width direction,
and each latch arm is provided with a retaining part projecting inward in the width direction, and the retaining part is provided with a guiding part that generates a component force acting outward in the width direction from a pressing force acting on the guiding part from the side opposite to the counterpart member in the thickness direction, a fixed side width fitting face facing inward in the width direction corresponding to the moving side width fitting face of the plug connector, and a fixed side depth fitting face facing inward in the depth direction corresponding to the moving side depth fitting face of the plug connector.

2. The receptacle connector with latch arms as recited in claim 1, wherein the retaining part is, when seen in the thickness direction, substantially a rectangle having the depth direction and the width direction as its two sides, and the retaining part is provided with a portion on its face opposite to the side of the counterpart member, the portion tilting inward in the width direction and coming closer to the counterpart member, and this portion provides the guiding part, or the corner inward in the width direction and inward in the depth direction of the retaining part is, when seen in the thickness direction, chamfered to provide the guiding part, and the inward end face in the width direction of the retaining part provides the fixed side width fitting face, and the inward end face in the depth direction of the retaining part provides the fixed side depth fitting face.

3. The receptacle connector with latch arms as recited in claim 1, wherein
the surface of the receptacle connector body on the side opposite to the counterpart member is provided by a metallic cover, and
the two latch arms are made of a metal, and the root ends of the respective latch arms are integrally provided on both ends in the width direction of the cover.

4. The receptacle connector with latch arms as recited in claim 2, wherein
the surface of the receptacle connector body on the side opposite to the counterpart member is provided by a metallic cover, and
the two latch arms are made of a metal, and the root ends of the respective latch arms are integrally provided on both ends in the width direction of the cover.

5. The plug connector to be connected to the receptacle connector with latch arms as recited in claim 1, the plug connector comprising
when a depth direction, a width direction and a thickness direction all being perpendicular to each other are assumed, an insulating plate-shaped plug connector body being, when seen in the thickness direction, substantially a rectangle having the depth direction and the width direction as its two sides, and
the contact having conductivity and being provided on the plug connector body, the contact comprising a contacting part being exposed at the inward edge in the depth direction of the plug connector body at least on one face in the thickness direction thereof and a connecting part to be connected to the electric wire or the flat type flexible cable, and
the moving side width fitting face facing outward in the width direction and the moving side depth fitting face facing outward in the depth direction, the both faces being provided on the plug connector body at two locations spaced from each other in the width direction thereof.

6. The plug connector to be connected to the receptacle connector with latch arms as recited in claim 2, the plug connector comprising
when a depth direction, a width direction and a thickness direction all being perpendicular to each other are assumed, an insulating plate-shaped plug connector body being, when seen in the thickness direction, substantially a rectangle having the depth direction and the width direction as its two sides, and
the contact having conductivity and being provided on the plug connector body, the contact comprising a contacting part being exposed at the inward edge in the depth direction of the plug connector body at least on one face in the thickness direction thereof and a connecting part to be connected to the electric wire or the flat type flexible cable, and
the moving side width fitting face facing outward in the width direction and the moving side depth fitting face facing outward in the depth direction, the both faces being provided on the plug connector body at two locations spaced from each other in the width direction thereof.

7. The plug connector to be connected to the receptacle connector with latch arms as recited in claim 3, the plug connector comprising
when a depth direction, a width direction and a thickness direction all being perpendicular to each other are assumed, an insulating plate-shaped plug connector body being, when seen in the thickness direction, substantially a rectangle having the depth direction and the width direction as its two sides, and
the contact having conductivity and being provided on the plug connector body, the contact comprising a contacting part being exposed at the inward edge in the depth direction of the plug connector body at least on one face in the thickness direction thereof and a connecting part to be connected to the electric wire or the flat type flexible cable, and
the moving side width fitting face facing outward in the width direction and the moving side depth fitting face facing outward in the depth direction, the both faces being provided on the plug connector body at two locations spaced from each other in the width direction thereof.

8. The plug connector to be connected to the receptacle connector with latch arms as recited in claim 4, the plug connector comprising
when a depth direction, a width direction and a thickness direction all being perpendicular to each other are assumed, an insulating plate-shaped plug connector body being, when seen in the thickness direction, substantially a rectangle having the depth direction and the width direction as its two sides, and
the contact having conductivity and being provided on the plug connector body, the contact comprising a contacting part being exposed at the inward edge in the depth direction of the plug connector body at least on one face in the thickness direction thereof and a connecting part to be connected to the electric wire or the flat type flexible cable, and
the moving side width fitting face facing outward in the width direction and the moving side depth fitting face facing outward in the depth direction, the both faces being provided on the plug connector body at two locations spaced from each other in the width direction thereof.

9. The plug connector as recited in claim 5, wherein concaved parts concaving in the thickness direction are provided in the corners at both ends in the width direction and outward in the depth direction of the plug connector body, and of the walls constituting these concaved parts, walls facing outward in the width direction provide the moving side width fitting faces and walls facing outward in the depth direction provide the moving side depth fitting faces.

10. The plug connector as recited in claim 6, wherein concaved parts concaving in the thickness direction are provided in the corners at both ends in the width direction and outward in the depth direction of the plug connector body, and of the walls constituting these concaved parts, walls facing outward in the width direction provide the moving side width fitting faces and walls facing outward in the depth direction provide the moving side depth fitting faces.

11. The plug connector as recited in claim 7, wherein concaved parts concaving in the thickness direction are provided in the corners at both ends in the width direction and outward in the depth direction of the plug connector body, and of the walls constituting these concaved parts, walls facing outward in the width direction provide the moving side width fitting faces and walls facing outward in the depth direction provide the moving side depth fitting faces.

12. The plug connector as recited in claim 8, wherein concaved parts concaving in the thickness direction are provided in the corners at both ends in the width direction and outward in the depth direction of the plug connector body, and of the walls constituting these concaved parts, walls facing outward in the width direction provide the moving side width fitting faces and walls facing outward in the depth direction provide the moving side depth fitting faces.
